(19) United States
(12) Patent Application Publication
(10) Pub. No.: US 2007/0086049 A1
(43) Pub. Date: Apr. 19, 2007

(54) IMAGE FORMING SYSTEM AND METHOD USING AUTHENTICATION INFORMATION, IMAGE FORMING APPARATUS, AUTHENTICATION INFORMATION PROVIDING DEVICE AND METHOD OF USING IMAGE FORMING APPARATUS

(76) Inventors: Joong-mok LEE, Yongin-si (KR); Kyeong-wook Ha, Suwon-si (KR)

Correspondence Address: STANZIONE & KIM, LLP, 919 18TH STREET, N.W., SUITE 440, WASHINGTON, DC, 20006, US

(21) Appl. No.: 11/530,587

(22) Filed: Sep. 11, 2006

(30) Foreign Application Priority Data
Oct. 19, 2005 (KR) 10-2005-98726
Oct. 19, 2005 (KR) 10-2005-98729

(51) Int. Cl. G06F 3/12

(52) U.S. Cl. 358/1.15; 358/1.14

(57) ABSTRACT

An image forming system and method using authentication information, an image forming apparatus, and an authentication information providing device and method to use an image forming apparatus. The image forming system includes an image forming apparatus to generate and to output authentication information and at least one host device to receive the authentication information, to add the received authentication information to image forming data, and to transmit the image forming data having the added authentication information to the image forming apparatus.

### CROSS-REFERENCE TO RELATED APPLICATIONS

This application claims priority under 35 U.S.C. §119(a) from Korean Patent Application No. 10-2005-0098726, filed on Oct. 19, 2005, in the Korean Intellectual Property Office, and priority under 35 U.S.C. §119(a) from Korean Patent Application No. 10-2005-0098727, filed on Oct. 19, 2005, in the Korean Intellectual Property Office, the disclosures of which are incorporated herein in their entireties by reference.

### BACKGROUND OF THE INVENTION

1. Field of the Invention

The present general inventive concept relates to a formation of images, and more particularly, to an image forming system and method using authentication information, in which an image forming operation can be performed securely without inputting authentication information to an image forming apparatus from a host computer. Further, the present general inventive concept relates to an authentication information providing device and method of using an image forming apparatus which can provide authentication information to use the image forming apparatus to a device connected thereto through a network.

2. Description of the Related Art

A conventional image forming apparatus, such as a printer, a copier, and a multifunction machine, receives image forming data from a host computer connected to the image forming apparatus, analyzes the received image forming data, and then carries out a formation of an image. At this time, for the purpose of restricting a use of the image forming apparatus, a user authentication procedure for using the image forming apparatus should be performed.

In the user authentication procedure, when a user inputs authentication information, such as identification data and a password, to a host computer, it is determined whether the input authentication information corresponds to identification data and a password(s) permitting the use of the image forming apparatus. When it is determined that the input authentication information corresponds to the identification data and the password(s) permitting the use of the image forming apparatus, the use of the image forming apparatus is permitted. However, when it is not determined that the input authentication information corresponds to identification data and passwords permitting the use of the image forming apparatus, the use of the image forming apparatus is not permitted.

However, there is an inconvenience in that a login procedure using a user interface should be carried out for the user authentication. In the user authentication procedure using a host computer, there is a problem that a user cannot use the image forming apparatus when the user forgets the authentication information. In addition, there is a problem that other persons having no authority can use the image forming apparatus without permission, when the authentication information is exposed to the other persons.

### SUMMARY OF THE INVENTION

The present general inventive concept provides an image forming system and method using authentication information, in which formation of images can be carried out securely without a loss and outflow of authentication information.

The present general inventive concept also provides an image forming apparatus which can carry out a formation of images securely without a loss and outflow of authentication information.

The present general inventive concept also provides an authentication information providing device and method of using an image forming apparatus, in which the image forming apparatus generates authentication information and provides the authentication information to a user permitted to use the image forming apparatus.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming system using authentication information, including an image forming apparatus to generate and to output authentication information, and at least one host device to receive the authentication information, to add the received authentication information to image forming data, and to transmit the image forming data having the added authentication information to the image forming apparatus, in which the image forming apparatus receives the image forming data having the added authentication information to form an image.

The foregoing and/or other aspects and utilities of the present general inventive concept may also be achieved by providing an image forming apparatus, including an authentication information generating unit to generate authentication information, a receiving unit to receive image forming data to which the generated authentication information is added, and an image forming unit to form an image corresponding to the image forming data.

The foregoing and/or other aspects and utilities of the present general inventive concept may also be achieved by providing an authentication information providing device to use an image forming apparatus, the device including an authentication information generating unit to generate authentication information to use the image forming apparatus; and an interface unit to transmit the generated authentication information to host devices permitted to use the image forming apparatus.

The foregoing and/or other aspects and utilities of the present general inventive concept may also be achieved by providing an image forming method including generating authentication information and outputting the generated authentication information to at least one host device, receiving the authentication information, adding the received authentication information to image forming data, and transmitting the image forming data having the added authentication information to an image forming apparatus, and receiving the image forming data having the added authentication information and forming an image using the image forming apparatus corresponding to the image forming data.

The foregoing and/or other aspects and utilities of the present general inventive concept may also be achieved by providing an authentication information providing method of using an image forming apparatus, the method including generating authentication information to use an image forming apparatus, and transmitting the generating authentication information to host devices permitted to use the image forming apparatus.

The foregoing and/or other aspects and utilities of the present general inventive concept may also be achieved by providing an authentication unit useable with an image forming apparatus, the authentication unit including an authentication information generating unit to generate authentication information to permit at least one authorized host device to use the image forming apparatus, and to transmit the generated authentication information to the at least one host device authorized to use the image forming apparatus, a determining unit to determine whether the generated authentication information was received by the at least one host device, and to generate second authentication information and transmit the second authentication information to the at least one host device when the determining unit determines that the generated authentication information was not received by the at least one host device, a comparing unit to compare the generated authentication information with authentication information included in image data transmitted to the image forming apparatus from the at least one host device, and an image forming unit to form an image using the image data based on the comparison result.

When the comparison result is that the generated authentication information does not correspond with the authentication information included in the image data, an image may not be formed and the image forming unit may generate an error message. The authentication information generating unit may generate first authentication information to permit a first group of host devices to use the image forming apparatus, and second authentication information different from the first authentication information to permit a second group of host devices to use the image forming apparatus.

The authentication information generating unit may generate the authentication information upon a powering on of the authentication information generating unit. The authentication information authentication information may include identification information and a password to permit the at least one host device to use the image forming apparatus. The authentication information generating unit may periodically-generate the authentication information at predetermined time intervals. The authentication information generating unit may transmit the generated authentication information to a plurality of host devices listed in a predetermined list stored in the image forming apparatus. The authentication information generating unit, the determining unit, the comparing unit, and the image generating unit may be disposed in the image forming apparatus.

The foregoing and/or other aspects and utilities of the present general inventive concept may also be achieved by providing an image forming system, including at least one host device to add stored authentication information to image data and to output the image data having the added authentication information, and an image forming apparatus to form an image corresponding to the image data, and including an authentication unit, the authentication unit including an authentication information generating unit to generate authentication information to permit the at least one host device to use the image forming apparatus, and to transmit the generated authentication information to the at least one host device, a determining unit to determine whether the generated authentication information was received by the at least one host device, and to generate second authentication information and to transmit the second authentication information to the at least one host device when the determining unit determines that the generated authentication information was not received by the at least one host device, a comparing unit to compare the generated authentication information with the added authentication information of the image data, and an image forming unit to form an image using the image data based on the comparison result.

When the comparison result is that the generated authentication information does not correspond with the authentication information included in the image data, an image may not be formed and the image forming unit may generate an error message. The authentication unit may store login information corresponding to users permitted to use the image forming apparatus, and may transmit the login information together with the generated authentication information to the at least one host device. The at least one host device may compare the transmitted login information transmitted from the authentication unit with user-input login information. The at least one host device may store the transmitted authentication information when the transmitted login information corresponds to the user-input login information. The at least one host device may add the stored authentication information to a header of the image data and may transmit the image data having the added authentication information to the image forming apparatus.

The authenticating unit may compare the generated authentication information with the added authentication information of the image data. The image forming apparatus may form the image corresponding to the image data when the generated authentication information corresponds to the added authentication information of the image data. The authenticating unit may generate an error message when the generated authentication information does not correspond to the added authentication information of the image data, and may send the error message to the at least one host device. At least one of the at least one host device and the image forming apparatus may display the error message.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an image forming system using authentication information, according to an embodiment of the present general inventive concept;

FIG. 2 is a flowchart illustrating an image forming method using authentication information, according to an embodiment of the present general inventive concept;

FIG. 3 is a flowchart illustrating operation 300 of the method illustrated in FIG. 2, according to an embodiment of the present general inventive concept;

FIG. 4 is a flowchart illustrating operation 302 of the method illustrated in FIG. 2, according to an embodiment of the present general inventive concept;

FIG. 5 is a flowchart illustrating operation 304 of the method illustrated in FIG. 2, according to an embodiment of the present general inventive concept;

FIG. 6 is a block diagram illustrating an authentication information providing device to use an image forming apparatus, according to an embodiment of the present general inventive concept; and

FIG. 7 is a flowchart illustrating an authentication information providing method of using an image forming apparatus, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

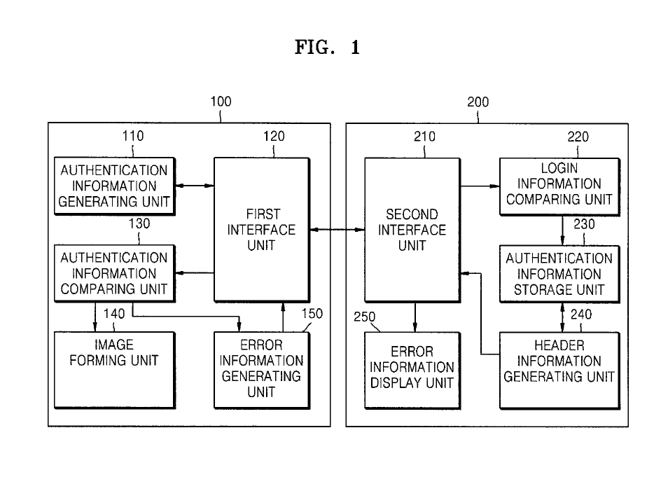

FIG. 1 is a block diagram illustrating an image forming system using authentication information, according to an embodiment of the present general inventive concept. The image forming system includes an image forming apparatus 100 and a host device, such as a host computer 200.

The image forming apparatus 100 includes an authentication information generating unit 110, a first interface unit 120, an authentication information comparing unit 130, an image forming unit 140, and an error information generating unit 150.

The image forming apparatus 100 generates authentication information to permit the use of the image forming apparatus 100 and outputs the authentication information to the host computer 200. The authentication information may include, for example, identification information and a password to permit the use of the image forming apparatus 100.

The authentication information generating unit 110 generates the authentication information to permit the use of the image forming apparatus 100 and outputs the generated authentication information to the first interface unit 120.

The authentication information generating unit 110 may generate like authentication information for a first plurality of host computers and may generate different authentication information for a second plurality of host computers. For example, when the first plurality of host computers forms a first group and the second plurality of host computers forms a second group, the authentication information generating unit 110 can generate like authentication information for the host computers belonging to the first group and can generate different authentication information for the host computers belonging to the second group. Thus, each of the host computers of the first group will share a first authentication information, each of the host computers of the second group will share a second authentication information, and the first and second authentication information may be different.

The authentication information generating unit 110 may periodically generate the authentication information within a first predetermined time period. For example, when the first predetermined time period is set to 30 minutes, the authentication information generating unit 110 generates the authentication information every 30 minutes. Since the authentication information is periodically generated within the first predetermined time period, the authentication information is generated more often as a length of the first predetermined time period is shortened, thereby further reinforcing security.

The first interface unit 120 transmits the generated authentication information to at least one host computer 200. An address list of the host computers 200 permitted to use the image forming apparatus 100 (a network address list) is stored in the image forming apparatus 100. The first interface unit 120 transmits the authentication information to the host computers 200 corresponding to the network address list stored in the image forming apparatus 100. The host computers 200 permitted to use the image forming apparatus 100 may include, but is not limited to including, personal computers, notebook computers, PDAs, and mobile terminals. Further, the first interface unit 120 determines whether the host computers 200 have received the authentication information, and outputs the determined result to the authentication information generating unit 110. For example, the host computers 200 may not be able to receive the authentication information when they are powered off.

When it is not determined that the host computer 200 has received the authentication information, the authentication information generating unit 110 generates new authentication information for the host computer 200. For example, when the first interface unit 120 determines that the host computer did not receive original authentication information within a second predetermined time period, the authentication information generating unit 110 generates new authentication information for the host computer 200 and outputs the newly generated authentication information to the first interface unit 120. The first interface unit 120 then transmits the received new authentication information to the host computer 200 that did not receive the original authentication information.

The second predetermined time period may be shorter than the first predetermined time period. For example, when the first period is set to 30 minutes, the second period may be set to 5 to 10 minutes. Accordingly, the new authentication information can be transmitted to the host computer 200 that did not receive the original authentication information within a short time period.

The image forming apparatus 100 stores login information of the host computers 200. The image forming apparatus 100 transmits the stored login information to the host computers 200 together with the authentication information generated by the authentication information generating unit 110. The login information serves as identification data of a user permitted to use the image forming apparatus 100. The login information may be stored in a predetermined storage unit (not illustrated) in the image forming apparatus 100 in advance.

The host computer 200 receives the authentication information from the image forming apparatus 100, adds the received authentication information to image forming data, and transmits the image forming data having the authentication information added thereto to the image forming apparatus 100.

The host computer 200 includes a second interface unit 210, a login information comparing unit 220, an authentication information storage unit 230, a header information generating unit 240, and an error information display unit 250.

The second interface unit 210 receives the authentication information and the login information transmitted together from the image forming apparatus 100 and outputs the received authentication information and the login information to the login information comparing unit 220.

The login information comparing unit 220 compares the login information transmitted together with the authentication information with login information of a user permitted to use the host computer 200 and outputs the comparison result to the authentication information storage unit 230.

When the authentication information storage unit 230 receives the comparison result indicating that the login information transmitted from the image forming apparatus 100 corresponds with the login information of the user permitted to use the host computer 200, the authentication information storage unit 230 stores the received authentication information in a predetermined memory space and outputs the stored authentication information to the header information generating unit 240 in response to a reading request of the header information generating unit 240.

The header information generating unit 240 receives and adds the stored and output authentication information to a header of the image forming data and outputs the image forming data to which the authentication information is added to the second interface unit 210. The header information generating unit 240 may be, for example, a printer driver installed in the host computer 200.

When the host computer 200 receives a request for formation of an image corresponding to the image forming data, the header information generating unit 240 requests the authentication information from the authentication information storage unit 230 . The header information generating unit 240 adds the authentication information read out from the authentication information storage unit 230 as header information to the image forming data.

The second interface unit 210 transmits the image forming data to which the authentication information is added to the image forming apparatus 100.

The first interface unit 120 receives the image forming data to which the authentication information is added from the host computer 200 and outputs the received image forming data to the authentication information comparing unit 130.

The authentication information comparing unit 130 compares the authentication information generated by the authentication information generating unit 110 and the authentication information included in the received image forming data. When the comparison result indicates that the authentication information generated by the authentication information generating unit 110 corresponds with the authentication information included in the received image forming data, the authentication information comparing unit 130 outputs the comparison result to the image forming unit 140. On the other hand, when the comparison result indicates that the authentication information generated by the authentication information generating unit 110 does not correspond with the authentication information included in the received image forming data, the authentication information comparing unit 130 outputs the comparison result to the error information generating unit 150.

The image forming unit 140 forms the image corresponding to the image forming data in response to the comparison result generated by the authentication information comparing unit 130 that the authentication information added to the image forming data corresponds with the authentication information generated by the authentication information generating unit 110.

The error information generating unit 150 generates error information that the formation of the image corresponding to the image forming data cannot be performed and outputs the generated error information to the first interface unit 120 in response to the comparison result generated by the authentication information comparing unit 130 that the authentication information added to the image forming data does not correspond with the authentication information generated from the authentication information generating unit 110.

The first interface unit 120 transmits the received error information to the host computer 200. The first interface unit 120 may use, for example, an electronic mail, a short message service, and/or a sound message to transmit the error information to the host computer 200. In addition, the first interface unit 120 outputs the received error information to a display unit (not illustrated) of the image forming apparatus 100. The display unit of the image forming apparatus 100 displays the received error information to allow the user to confirm the error information. The second interface unit 210 of the host computer 200 receives the error information and outputs the received error information to the error information display unit 250. The error information display unit 250 displays the received error information on a display screen.

An image forming method using authentication information, according to the present general inventive concept, will now be described in detail with reference to the attached drawings.

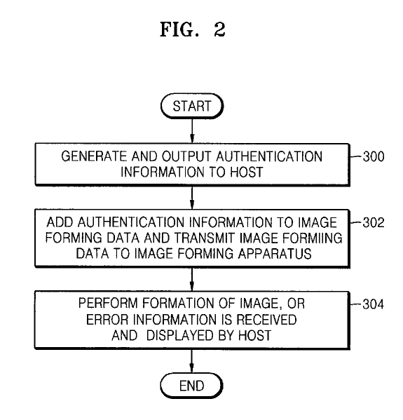

FIG. 2 is a flowchart illustrating an image forming method using authentication information, according to an embodiment of the present general inventive concept. Referring to FIG. 2, authentication information is generated and output to at least one host device, such as a host computer at operation 300. The authentication information may include identification data and a password to permit a use of an image forming apparatus.

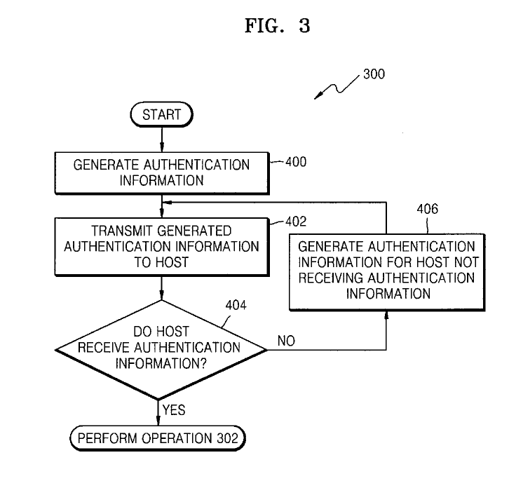

FIG. 3 is a flowchart illustrating operation 300 of the method illustrated in FIG. 2, according to an embodiment of the present general inventive concept. Referring to FIG. 3, the authentication information is generated (operation 400). Like authentication information may be generated for a first plurality of host computers and different authentication information may be generated for a second plurality of host computers. The authentication information may be periodically generated within a first predetermined time period.

Subsequent to operation 400, the generated authentication information is transmitted to the at least one host computer (operation 402). An address list of host computers permitted to use the image forming apparatus is stored in the image forming apparatus. The authentication information may be transmitted to the host computers corresponding to the stored address list. Examples of host computers that may be permitted to use the image forming apparatus can include a personal computer, a notebook computer, a PDA, and a mobile terminal.

Subsequent to operation 402, it is determined whether the at least one host computer receives the authentication information (operation 404). When it is determined that the host computer does not receive the authentication information, new authentication information for the host computer that did not receive the authentication information is generated within a second predetermined time period (operation 406). The second predetermined time period may be shorter than the first predetermined time period. Accordingly, the new authentication information can be transmitted to the host computer that did not receive the authentication information within a short time period. Furthermore, in operation 300, login information of the at least one host computer, which is stored in the image forming apparatus, is transmitted to the at least one host computer together with the authentication information. The login information may indicate identification data of a user permitted to use the at least one host computer.

Referring to FIG. 2, subsequent to operation 300, the authentication information is received by the at least one host computer, the received authentication information is added to the image forming data, and the image forming data and received authentication information are together transmitted to the image forming apparatus (operation 302).

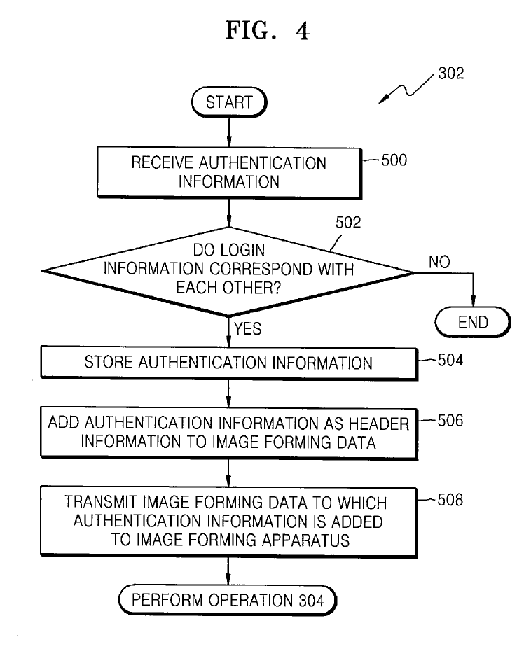

FIG. 4 is a flowchart illustrating operation 302 of the method illustrated in FIG. 2, according to an embodiment of the present general inventive concept. Referring to FIG. 4, the authentication information and the login information are received by the at least one host computer from the image forming apparatus (operation 500).

Subsequent to operation 500, it is determined whether the login information transmitted together with the authentication information corresponds with the login information of the host computer (operation 502).

When the login information transmitted together with the authentication information does not correspond with the login information of the host computer, the image forming method ends. When the login information transmitted together with the authentication information corresponds with the login information of the host computer, the received authentication information is stored in the at least one host computer (operation 504).

Subsequent to operation 504, the stored authentication information is added as header information to the image forming data (operation 506).

Subsequent to operation 506, the image forming data to which the authentication information is added are transmitted to the image forming apparatus (operation 508).

Referring to FIG. 2, subsequent to operation 302, the image forming data to which the authentication information is added are received and then the formation of an image is performed or error information received by the at least one host computer is displayed (operation 304).

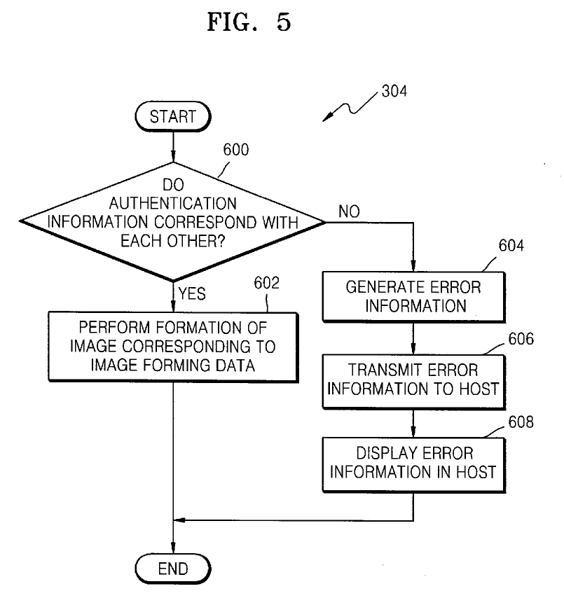

FIG. 5 is a flowchart illustrating operation 304 of the method illustrated in FIG. 2, according to an embodiment of the present general inventive concept. Referring to FIG. 5, the authentication information added to the image forming data is compared to the authentication information generated in operation 300 (operation 600).

When the authentication information added to the image forming data corresponds with the authentication information generated in operation 300, the formation of the image corresponding to the image forming data is performed (operation 602).

In contrast, when the authentication information added to the image forming data does not correspond with the authentication information generated in operation 300, the error information indicating that the formation of the image corresponding to the image forming data cannot be performed is generated (operation 604).

Subsequent to operation 604, the generated error information is transmitted to the at least one host computer (operation 606). An electronic mail, a short message service (SMS), or a sound message is used to transmit the error information to the host computer 200. The generated error information may also be displayed on a display screen of the image forming apparatus.

Subsequent to operation 606, the error information is received by the at least one host computer and the received error information is displayed on a display screen of the host computer (operation 608).

Moreover, image forming methods using authentication information according to various embodiments of the present embodiment can be embodied as computer readable codes and/or instructions and/or programs. For example, the methods can be embodied by a general-purpose computer to execute the codes and/or instructions and/or programs on a computer readable recording medium.

The computer readable recording medium may be any data storage device that can store data which can be thereafter read by a computer system. Examples of the computer readable recording medium include, but are not limited to, read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present general inventive concept can be easily construed by programmers skilled in the art to which the present general inventive concept pertains.

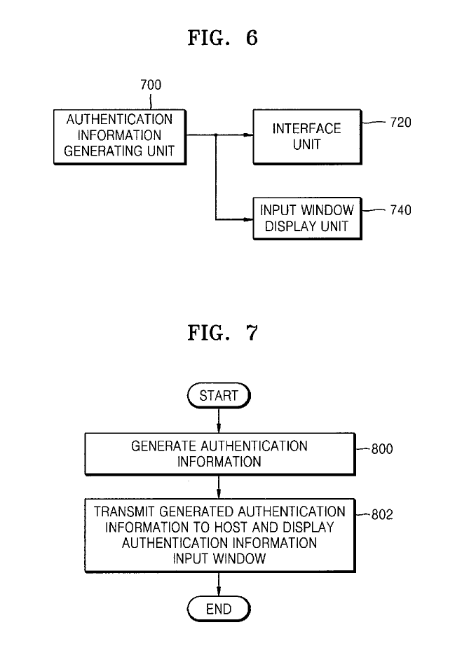

Now, an authentication information providing device to use an image forming apparatus, according to and embodiment of the present general inventive concept, will be described in detail with reference to FIG. 6.

FIG. 6 is a block diagram illustrating an authentication information providing device to use an image forming apparatus, according to an embodiment of the present general inventive concept. The authentication information providing device includes an authentication information generation unit 700, an interface unit 720, and an input window display unit 740. The authentication information generating unit 700, the interface unit 720, and the input window display unit 740 may be provided in the image forming apparatus.

The authentication information generating unit 700 generates the authentication information to use the image forming apparatus and outputs the generated authentication information to the interface unit 720 and the input window display unit 740. The authentication information may include identification data and a password to permit the use of the image forming apparatus.

The authentication information generating unit 700 may generate like authentication information or different authentication information for host devices, such as host computers, permitted to use the image forming apparatus. For example, when a first plurality of host computers form a first group, and a second plurality of host computers forms a second group, the authentication information generating unit 700 can generate like authentication information for the host computers belonging to the first group and can generate different authentication information for the host computers belonging to the second group. Thus, each of the host computers of the first group will share a first authentication information, each of the host computers of the second group will share a second authentication information, and the first and second authentication information may be different.

The authentication information generating unit 700 periodically generates the authentication information after the image forming apparatus is powered on. By generating the authentication information whenever the image forming apparatus is powered on, the authentication information can be provided to users who want to use the image forming apparatus.

The interface unit 720 transmits the authentication information received from the authentication information generating 700 to the host computers permitted to use the image forming apparatus. The interface unit 720 stores a network address list of the host computers permitted to use the image forming apparatus. The network address list includes addresses of the host computers permitted to use the image forming apparatus. Therefore, the interface unit 700 transmits the authentication information to the host computers corresponding to the network address list stored in the interface unit 720. Examples of the host computers permitted to use the image forming apparatus include, but are not limited to, personal computers, notebook computers, PDAs, and mobile terminals. When the host computer is a personal computer, a notebook computer, or a PDA, the interface unit 720 can transmit the authentication information to the personal computer, the notebook computer, or the PDA through an electronic mail. When the host computer is a mobile terminal, the interface unit 720 can transmit the authentication information to the mobile terminal through a sound message or a character message. However, these transmission methods are only examples and the authentication information may be transmitted in a variety of methods other than the above-mentioned transmission methods.

The input window display unit 740 displays an authentication information input window. A user can recognize the authentication information to use the image forming apparatus by receiving the authentication information transmitted from the image forming apparatus through, for example, the personal computer, the notebook computer, the PDA, or the mobile terminal. The user can use the image forming apparatus by inputting the recognized authentication information to the image forming apparatus. For this purpose, the image forming apparatus may display an input window to input the authentication information using the input window display unit 740.

Now, an authentication information providing method of using an image forming apparatus, according to an embodiment of the present general inventive concept, will be described in detail with reference to FIG. 7.

FIG. 7 is a flowchart illustrating an authentication information providing method of using an image forming apparatus, according to an embodiment of the present general inventive concept. Referring to FIG. 7, authentication information to use the image forming apparatus is generated (operation 800). Like authentication information or different authentication information may be generated for a plurality of host devices, such as host computers, permitted to use the image forming apparatus. The authentication information to use the image forming apparatus may be generated when the image forming apparatus is powered on. By generating the authentication information whenever the image forming apparatus is powered on, the authentication information is provided to users who want to use the image forming apparatus.

Subsequent to operation 800, the generated authentication information is transmitted to the host computers permitted to use the image forming apparatus and an authentication information input window is displayed (operation 802).

A network address list of the host computers permitted to use the image forming apparatus is stored in advance. The authentication information is transmitted to the host computers corresponding to the stored network address list. The authentication information is transmitted to any one of, for example, a personal computer, a notebook computer, a PDA, and a mobile terminal as the host computer permitted to use the image forming apparatus. When the host computer is a personal computer, a notebook computer, or a PDA, the authentication information may be transmitted to the personal computer, the notebook computer, or the PDA through an electronic mail. When the host computer is a mobile terminal, the authentication information may be transmitted to the mobile terminal through a sound message or a character message.

A user can use the image forming apparatus by inputting the received authentication information, which is received by, for example, the personal computer, the notebook computer, the PDA, or the mobile terminal, to the input window of the image forming apparatus. The authentication information providing method of using an image forming apparatus may be executed within the image forming apparatus.

Moreover, authentication information providing methods according to various embodiments of the present general inventive concept can be embodied as computer readable codes and/or instructions and/or programs. For example, the methods can be embodied by a general-purpose computer to execute the codes and/or instructions and/or programs on a computer readable recording medium.

The computer readable recording medium may be any data storage device that can store data which can be thereafter read by a computer system. Examples of the computer readable recording medium include, but are not limited to, read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present general inventive concept can be easily construed by programmers skilled in the art to which the present general inventive concept pertains.

In an image forming system and method and an image forming apparatus using authentication information, according to various embodiments of the present general inventive concept, since the image forming apparatus generates the authentication information without an interruption of a user, transmits the authentication information to the host computer registered in advance, receives the transmitted authentication information along with the image forming data, performs an authentication procedure, and forms an image, it is possible to form the image securely without a loss and outflow of the authentication information. Thus, the authentication to use the image forming apparatus can be conveniently completed by allowing the user to log into the host computer. Since the image forming apparatus generates the authentication information and notifies the user permitted to use the image forming apparatus of the authentication information, it is possible to prevent a user not permitted to use the image forming apparatus from using the image forming apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming system using authentication information, comprising:
an image forming apparatus to generate and output authentication information; and
at least one host device to receive the authentication information, to add the received authentication information to image forming data, and to transmit the image forming data having the added authentication information to the image forming apparatus,
wherein the image forming apparatus receives the image forming data having the added authentication information to form an image.

2. The image forming system of claim 1, wherein the image forming apparatus comprises:
an authentication information generating unit to generate the authentication information;
a first interface unit to transmit the generated authentication information to the at least one host device and to receive the image forming data having the added authentication information;
an authentication information comparing unit to compare the authentication information generated by the authentication information generating unit to the authentication information added to the image forming data; and
an image forming unit to form the image corresponding to the image forming data based on the comparison result.

3. The image forming system of claim 1, wherein the image forming apparatus stores an address list of host devices permitted to use the image forming apparatus and transmits the authentication information to the listed host devices permitted to use the image forming apparatus.

4. The image forming system of claim 2, wherein the image forming apparatus further comprises:
an error information generating unit to generate error information corresponding to the image forming data when the authentication information comparing unit determines that the authentication information added to the image forming data does not agree with the authentication information generated by the authentication information generating unit,
wherein the generated error information is displayed on at least one of the at least one host device and the image forming apparatus.

5. The image forming system of claim 1, wherein the at least one host device comprises:
a second interface unit to receive the authentication information transmitted from the image forming apparatus and to transmit the image forming data having the added authentication information to the image forming apparatus;
an authentication information storage unit to store the received authentication information; and
a header information generating unit to add the stored authentication information to header information of the image forming data and to output the image forming data to the second interface unit.

6. The image forming system of claim 5, wherein the image forming apparatus stores login information of the at least one host device and transmits the stored login information to the at least one host device together with the authentication information.

7. The image forming system of claim 6, wherein the at least one host device further comprises:
a login information comparing unit to compare the login information transmitted together with the authentication information from the image forming apparatus with the login information of the at least one host device,
wherein the authentication information storage unit stores the received authentication information in response to the comparison result of the login information comparing unit.

8. The image forming system of claim 5, wherein the at least one host device further comprises:
an error information display unit to receive error information indicating that the image corresponding to the image forming data cannot be formed and to display the received error information.

9. An image forming apparatus, comprising:
an authentication information generating unit to generate authentication information;
a receiving unit to receive image forming data to which the generated authentication information is added; and
an image forming unit to form an image corresponding to the image forming data.

10. The image forming apparatus of claim 9, further comprising:
a first interface unit to transmit the generated authentication information to a host device and to receive the image forming data having the added authentication information; and
an authentication information comparing unit to compare the authentication information generated by the authentication information generating unit with the authentication information added to the image forming data,
wherein the image forming unit forms the image corresponding to the image forming data based on the comparison result.

11. The image forming apparatus of claim 10, further comprising:
an error information generating unit to generate error information corresponding to the image forming data when the authentication information comparing unit determines that the authentication information added to the image forming data does not agree with the authentication information generated by the authentication information generating unit,
wherein the generated error information is displayed on at least one of the host device and the image forming apparatus.

12. An image forming method, comprising:
generating authentication information and outputting the generated authentication information to at least one host device;
receiving the authentication information, adding the received authentication information to image forming data, and transmitting the image forming data having the added authentication information to an image forming apparatus; and
receiving the image forming data having the added authentication information and forming an image using the image forming apparatus corresponding to the image forming data.

13. The image forming method of claim 12, wherein the generating and outputting of the authentication information comprises:
storing an address list of host devices permitted to use the image forming apparatus; and
transferring the authentication information to the listed host devices.

14. The image forming method of claim 12, wherein the receiving of the authentication information comprises:
receiving the generated authentication information;
storing the received authentication information;
adding the stored authentication information to header information of the image forming data; and
transmitting the image forming data having the added authentication information to the image forming apparatus.

15. The image forming method of claim 12, wherein the receiving of the image forming data comprises:
comparing the generated authentication information with the authentication information added to the image forming data; and
forming the image corresponding to the image forming data when the authentication information added to the image forming data agrees with the generated authentication information.

16. The image forming method of claim 15, wherein the receiving of the image forming data further comprises:
generating error information corresponding to the image forming data when the authentication information added to the image forming data does not agree with the generated authentication information; and
transmitting the generated error information to the host device.

17. A computer readable recording medium including a program to execute an image forming method, the method comprising:
generating authentication information and outputting the generated authentication information to at least one host device;
receiving the authentication information, adding the received authentication information to image forming data, and transmitting the image forming data having the added authentication information to an image forming apparatus; and
receiving the image forming data having the added authentication information and forming an image using the image forming apparatus corresponding to the image forming data.

18. An authentication information providing device to use an image forming apparatus, the device comprising:
an authentication information generating unit to generate authentication information to use the image forming apparatus; and
an interface unit to transmit the generated authentication information to host devices permitted to use the image forming apparatus.

19. An authentication information providing method of using an image forming apparatus, the method comprising:
generating authentication information to use an image forming apparatus; and
transmitting the generating authentication information to host devices permitted to use the image forming apparatus.

20. A computer readable recording medium including a program to execute an authentication information providing method, the method comprising:
generating authentication information to use an image forming apparatus; and
transmitting the generating authentication information to host devices permitted to use the image forming apparatus.

21. An authentication unit useable with an image forming apparatus, the authentication unit comprising:
an authentication information generating unit to generate authentication information to permit at least one authorized host device to use the image forming apparatus, and to transmit the generated authentication information to the at least one host device authorized to use the image forming apparatus;
a determining unit to determine whether the generated authentication information was received by the at least one host device, and to generate second authentication information and transmit the second authentication information to the at least one host device when the determining unit determines that the generated authentication information was not received by the at least one host device;
a comparing unit to compare the generated authentication information with authentication information included in image data transmitted to the image forming apparatus from the at least one host device; and
an image forming unit to form an image using the image data based on the comparison result.

22. The authentication unit of claim 21, wherein when the comparison result is that the generated authentication information does not correspond with the authentication information included in the image data, an image is not formed and the image forming unit generates an error message.

23. The authentication unit of claim 21, wherein the authentication information generating unit generates first authentication information to permit a first group of host devices to use the image forming apparatus, and second authentication information different from the first authentication information to permit a second group of host devices to use the image forming apparatus.

24. The authentication unit of claim 21, wherein the authentication information generating unit generates the authentication information upon a powering on of the authentication information generating unit.

25. The authentication unit of claim 21, wherein the authentication information authentication information comprises identification information and a password to permit the at least one host device to use the image forming apparatus.

26. The authentication unit of claim 21, wherein the authentication information generating unit periodically-generates the authentication information at predetermined time intervals.

27. The authentication unit of claim 21, wherein the authentication information generating unit transmits the generated authentication information to a plurality of host devices listed in a predetermined list stored in the image forming apparatus.

28. The authentication unit of claim 21, wherein the authentication information generating unit, the determining unit, the comparing unit, and the image generating unit are disposed in the image forming apparatus.

29. An image forming system, comprising:
at least one host device to add stored authentication information to image data and to output the image data having the added authentication information; and
an image forming apparatus to form an image corresponding to the image data, and including an authentication unit, the authentication unit comprising:
an authentication information generating unit to generate authentication information to permit the at least one host device to use the image forming apparatus, and to transmit the generated authentication information to the at least one host device,
a determining unit to determine whether the generated authentication information was received by the at least one host device, and to generate second authentication information and to transmit the second authentication information to the at least one host device when the determining unit determines that the generated authentication information was not received by the at least one host device,
a comparing unit to compare the generated authentication information with the added authentication information of the image data, and
an image forming unit to form an image using the image data based on the comparison result.

30. The image forming system of claim 29, wherein when the comparison result is that the generated authentication information does not correspond with the authentication information included in the image data, an image is not formed and the image forming unit generates an error message.

31. The image forming system of claim 29, wherein the authentication unit stores login information corresponding to users permitted to use the image forming apparatus, and transmits the login information together with the generated authentication information to the at least one host device.

32. The image forming system of claim 29, wherein the at least one host device compares the transmitted login information transmitted from the authentication unit with user- input login information.

33. The image forming system of claim 32, wherein the at least one host device stores the transmitted authentication information when the transmitted login information corresponds to the user-input login information.

34. The image forming system of claim 33, wherein the at least one host device adds the stored authentication information to a header of the image data and transmits the image data having the added authentication information to the image forming apparatus.

35. The image forming system of claim 34, wherein the authenticating unit compares the generated authentication information with the added authentication information of the image data.

36. The image forming system of claim 35, wherein the image forming apparatus forms the image corresponding to the image data when the generated authentication information corresponds to the added authentication information of the image data.

37. The image forming system of claim 35, wherein the authenticating unit generates an error message when the generated authentication information does not correspond to the added authentication information of the image data, and sends the error message to the at least one host device.

38. The image forming system of claim 37, wherein at least one of the at least one host device and the image forming apparatus displays the error message.
